(19) United States
(12) Patent Application Publication
(10) Pub. No.: US 2003/0110080 A1
(43) Pub. Date: Jun. 12, 2003

(54) Advertisement distribution determining/optimizing method

(76) Inventors: Yuzi Tsutani, Tokyo (JP); Nanako Higashi, Tokyo (JP)

Correspondence Address: GRIFFIN & SZIPL, PC, SUITE PH-1, 2300 NINTH STREET, SOUTH, ARLINGTON, VA, 22204, US

(21) Appl. No.: 10/258,516

(22) PCT Filed: Apr. 25, 2001
(86) PCT No.: PCT/JP01/03552

(30) Foreign Application Priority Data
Apr. 26, 2000 (JP) 2000-126013
Jul. 11, 2000 (JP) 2000-209310

(51) Int. Cl. G06F 17/60

(52) U.S. Cl. 705/14; 705/10

(57) ABSTRACT

To create a media plan in which various advertisement publications including the distribution of an advertising banner is optimized When accepting a manuscript created through an advertising agency (14) or a REP (16) and including information indicative of a period, a budget and a target user, a media plan creating server (18) acquires data including an access log of internet of a sample user in a sample family from an internet audience behavior research institution (20). Next, the media plan creating server (18) selects a predetermined number of prospective sites presumed to have an advertising effect based on the access log of the user which is coincident with conditions of the target user, and calculates an index to find a combination thereof in relation to the prospective sites. A media plan in which an advertisement period and a budget are allocated to each of the combinations is transmitted to the advertising agency (14) or the REP (16).

### INDUSTRIAL APPLICABLE FIELD

The present invention relates to a method for optimizing an advertisement to be distributed to a site on internet. More specifically, the present invention relates to a method for optimizing a media plan describing a plan for publishing and distributing an advertisement to respective media.

### BACKGROUND OF THE INVENTION

By the spread of internet, various sites have been produced and a desirable site can be read according to a user's taste In these sites, an anchor of an advertising banner presented by a sponsor is provided. The user clicks the advertising banner for information to be known and goods to be purchased by himself (herself) and can access the linked site. Consequently, the user can get the desired information and the like.

The users are interested in information and goods with a great difference depending on an attribute (an age, a sex, a residence and the like to which they belong). Therefore, an advertising banner having a high hit ratio is greatly varied depending on the site.

In the conventional advertising distribution, however, there has not been established a method for distributing an advertising banner to a site. In other words, an advertising agency or the like has determined the distribution of a specific advertisement to a specific site according to experiences. Therefore, the advertisement cannot be distributed properly and it is hard to obtain a high hit ratio.

Moreover, a newspaper, a magazine, a television broadcast and a radio broadcast according to the conventional art have been known as advertising media. Furthermore, a method for sending a direct mail to latent customers can be supposed to be one of the advertising methods. By utilizing such media, an advertisement has conventionally been sent to so many people. Moreover, it has also been possible to accept the response of latent customers (potential customers) for the advertisement of the mass media through a reply card or telephone reception.

However, it takes a time to collect the response depending on the acceptance, and furthermore, a long time is required for totalizing the response. In other words, the cost is required very greatly so that the response of the latent customers cannot be actually utilized effectively.

On the other hand, advertising to a site on the internet and business activities through a call center have also been taken seriously because of the spread of the recent internet or the development of a CTI (computer telephony integration) technique. In the internet and the call center, particularly, it is possible to collect the response of the latent customers in real time. Therefore, it is possible to directly know a reaction to goods and services in real time.

In order to determine the distribution of advertisements to the advertising media, particularly, conventional advertising media (a newspaper, a magazine, a television and a radio), a media plan has been created based on a planer's experience on the basis of the campaign project of goods. However, there has been a problem in that the conventional media plan lacks objectivity because it is based on the planer's experience.

On the other hand, it is possible to get the response of the latent customers more directly in real time in respect of the spread of the internet and the CTI.

It is an object of the present invention to provide a method for determining a distribution destination of an advertisement to be optimized and a system for optimizing the distribution.

In the present invention, moreover, attention has been paid to the positive utilization of the response of the latent customers and the response of the latent customers is utilized to determine a combination of media to which an advertisement is to be published or distributed. More specifically, it is another object to provide a media plan creating system capable of creating a proper media plan for publishing or distributing an advertisement to various advertising media.

### DISCLOSURE OF THE INVENTION

The above mentioned object can be achieved by providing an advertisement distribution determining method of determining a site to which an advertising banner is to be distributed based on a media plan including a target user, comprising the steps of accepting a manuscript created through an advertising agency and/or a REP and including information indicative of a period, a budget and a target user, acquiring data including an attribute of a sample user in a sample family and an access log of internet of the user, selecting a predetermined number of prospective sites presumed to have an advertising effect based on an access log of the user which is coincident with conditions of the target user in the sample user, calculating an index in relation to the prospective site to find a combination of the prospective sites, and generating a media plan in which an advertisement period and a budget are allocated to each combination of the prospective sites, thereby transmitting the media plan.

According to the present invention, in such circumstances that the class of a reader of the site cannot be grasped objectively, it is possible to acquire the access log of the sample user stored in the audience behavior database of an audience behavior research institution or the like and to specify, as a prospective site, a site viewed by many users to be targets of an advertising banner. Moreover, when the combination of the prospective sites is to be determined, it is possible to obtain an optimum combination by utilizing the index.

In a preferred embodiment of the present invention, the attributes in the sample family and the related access log are acquired from an audience behavior database owned by an institution for researching an audience behavior.

In another preferred embodiment of the present invention, the sample user which is coincident with the condition of the target user is selected and a prospective site is selected based on an access log of the selected user. Alternatively, it is also possible to previously acquire the information of the user which is coincident with the condition of the target user from the institution for researching the audience behavior.

In a further preferred embodiment of the present invention, the step of selecting the prospective site includes the steps of calculating an average impression ratio of each site by a selected user, calculating a cost of advertisement publication of each site and a cost performance based on a ratio with the average impression ratio, and setting, to a prospective site, a predetermined number of sites in high order of the cost performance.

According to the present embodiment, it is possible to select the prospective site taking an advertising effect and a cost into consideration in consideration of a cost of advertisement publication as well as the average impression ratio of the target to the site.

In a further preferred embodiment of the present invention, any of an impression, an effective reach and a click through ratio or an optional combination thereof is utilized as the index.

In the above case, any one of the impression, the effective reach and the click through ratio may be selected. Alternatively, a plurality of weights of any of the impression, the effective reach and the click through are determined respectively and the index may be calculated in consideration of the weight.

In a further preferred embodiment of the present invention, moreover, the step of generating a media plan includes the step of generating information indicative of a period in which an advertising banner is to be distributed to each site and/or a cost required for the distribution for the same period.

Consequently, it is possible to properly give an instruction for advertising banner distribution based on the media plan in the REP or the like.

Furthermore, the object of the present invention can be achieved by providing a distribution optimizing system for determining an optimum site to which an advertising banner is to be distributed based on a manuscript created through an advertising agency and/or a REP and including information indicative of a period, a budget and a target user on the basis of a media plan including the target user, comprising prospect site selecting means for acquiring data including an attribute of a sample user in a sample family and an access log of internet of the user and selecting a predetermined number of prospective sites presumed to have an advertising effect based on an access log of the user which is coincident with conditions of the target user in the sample user, index calculating means for calculating an index in relation to the prospective site to find a combination of the prospective sites, and media plan generating means for generating a media plan in which an advertisement period and a budget are allocated to each combination of the prospective sites, wherein the media plan having the distribution destination optimized is transmitted to the REP and/or the advertising agency.

Moreover, another object of the present invention can be achieved by a media plan creating system for specifying a plurality of individual vehicles to which an advertisement is to be published or distributed based on an advertising manuscript and for creating a combined media plan, comprising a database for storing information indicative of the individual vehicle indicative of a medium to which an advertisement published or distributed has specifically been published or distributed, contents of the advertisement, a cost of the advertisement and a user's reaction to the advertisement, and media plan creating means for creating a media plan including an advertisement period and a budget for a selected one of the individual vehicles to maximize the user's reaction based on a manuscript sent from an advertiser and/or an advertising agency to which information including an advertisement period and a budget is given.

According to the present invention, the data base storing the user's past reaction is referred to create a media plan including an advertisement period and a budget through the individual vehicle to maximize the user's reaction. Accordingly, it is possible to select any of many individual vehicles which are presumed to obtain the user's reaction most greatly and to create a media plan including the same individual vehicle.

In a preferred embodiment of the present invention, the information indicative of the user's reaction to the advertisement includes at least the number of responses given from the user, the number of material requests given from the user, and the number of contracts made by the user.

In a further preferred embodiment of the present invention, the media plan creating means selects a combination of a plurality of individual vehicles in consideration of any of a cost of an advertisement related to the individual vehicle, the number of responses, the number of material requests and the number of contracts. Consequently, it is possible to obtain a combination of the individual vehicles having the highest cost performance.

In a further preferred embodiment of the present invention, the manuscript includes information indicative of a user's attribute to be a target, the database stores information indicative of the user's reaction for each user's attribute, and the media plan creating system refers to the user's attribute of the target user in the manuscript to create a media plan in order to maximize the user's reaction having the user's attribute for the individual vehicle. Consequently, it is possible to obtain a combination of the individual vehicles which gives the reaction of the user to be a target most greatly.

In a further preferred embodiment of the present invention, the media plan creating means selects a plurality of the individual vehicles in consideration of a ratio of the user's reaction having the user's attribute to a cost of an advertisement related to the individual vehicle, and obtains a combination of the individual vehicles to optimize the user's reaction.

Moreover, a further object of the present invention can be achieved by providing a media plan creating method of creating a media plan specifying at least one individual vehicle to which an advertisement is to be published or distributed based on an advertisement manuscript, comprising the steps of accepting a manuscript sent from an advertiser and/or an advertising agency to which information including an advertisement period and a budget is given, referring to information indicative of the individual vehicle indicative of a medium to which an advertisement stored in a database and published or distributed has specifically been published or distributed, contents of the advertisement, a cost of the advertisement and a user's reaction to the advertisement, and creating a media plan including an advertisement period and a budget for a selected one of the individual vehicles to maximize the user's reaction.

Furthermore, it is desirable that the method should further comprise the steps of acquiring a user's reaction based on publication and distribution of an advertisement on the basis of the media plan, and storing the user's reaction in a database in relation to the individual vehicle, contents of the advertisement and a cost of the advertisement. Consequently, the information about the reaction to the advertisement having a media plan can be stored and a more proper media plan can be obtained by using the stored information.

### BRIEF DESCRIPTION OF THE DRAWINGS

FIG. 1 is a block diagram showing the schematic structure of an advertisement distributing system according to a first embodiment of the present invention,

FIG. 2 is a flow chart showing a general flow from the creation of an advertising manuscript to distribution to a site according to the first embodiment,

FIG. 3 is a diagram showing an example of data to be given from an audience behavior research server to a media plan generation server according to the first embodiment,

FIG. 4 is a flow chart showing a processing to be executed by the media plan generation server according to the first embodiment,

FIG. 5 is a flow chart showing a processing to be executed by the media plan generation server according to the first embodiment, which is to be executed subsequently to FIG. 4,

FIGS. 6A and 6B are diagrams showing an example of a campaign project and an optimized media plan calculated based thereon according to the first embodiment, respectively,

FIG. 7 is a diagram showing an example of advertising banner distribution to a site according to the first embodiment,

FIG. 8 is a block diagram schematically showing a media plan creating system and the vicinity thereof according to a second embodiment,

FIG. 9 is a flow chart showing a general flow from the generation of the outline of an advertisement for certain goods and the like to advertisement publication/distribution and the feedback of a result thereof according to the second embodiment,

FIG. 10 is a diagram illustrating items to be executed on respective sides of a company, an advertising agency and a media plan creating system according to the second embodiment,

FIGS. 11A and 11B are diagrams showing the structure of a data group stored in DB of the media plan creating system according to the second embodiment,

FIGS. 12A and 12B are diagrams illustrating the expression form of media and advertisements according to the second embodiment, respectively,

FIG. 13 is a flow chart showing a processing to be executed by the media plan creating system according to the second embodiment,

FIG. 14 is a flow chart showing the processing to be executed by the media plan creating system according to the second embodiment,

FIGS. 15A and 15B are diagrams showing an example of a media plan created according to the second embodiment and the prediction of an effect thereof, respectively, and

FIG. 16 is a flow chart showing a processing to be executed by a media plan creating system for the feedback to the company or the advertising agency according to the second embodiment.

### BEST MODE FOR CARRYING OUT THE INVENTION

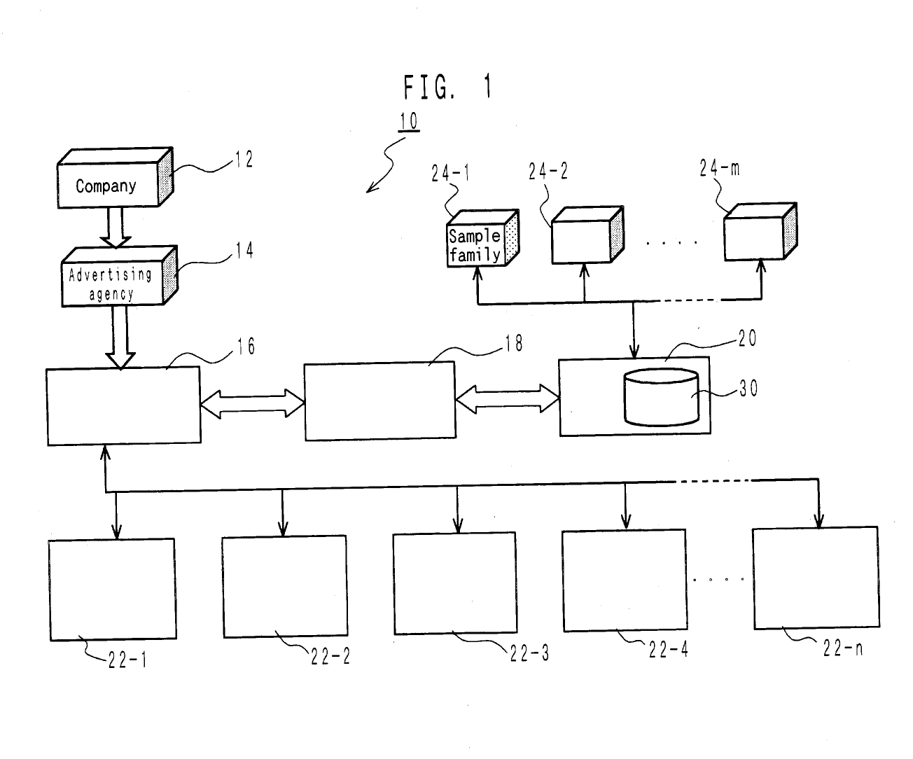

Embodiments of the present invention will be described below with reference to the drawings. FIG. 1 is a block diagram showing the schematic structure of an advertisement distributing system according to a first embodiment of the present invention. As shown in FIG. 1, an advertisement distributing system 10 has a company 12 which requests an advertisement for goods thereof, an advertising agency 14, an internet advertising agency server 16 for accepting a manuscript for an advertisement for certain goods from the advertising agency and creating data which can be distributed through internet, a media plan creating server 18 for specifying a site to be a distribution destination (target) of an advertisement, and an audience behavior research server 20 for researching the audience behavior of the internet. The internet advertising agency is generally referred to as a REP. In this specification, a server provided in the internet advertising agency will be hereinafter referred to as a REP server 16.

The company 12 and the advertising agency 14 may be connected on-line through WAN or internet by a server or off-line. Moreover, the advertising agency 14 and the REP (REP server 16) may also be connected on-line or off-line. The REP server 16 and the media plan creating server 18, and the media plan creating server 18 and the audience behavior research server 20 are connected through the WAN or the internet, respectively. Moreover, the REP server 16 is connected to various sites 22-1, 22-2, . . . , 22-n through the internet. Furthermore, the audience behavior research server 20 is connected to a personal computer (not shown) of a sample family (sample families 24-1, 24-2, . . . , 24-m). In this specification, the site includes contents on the computer which is used with an independent domain.

FIG. 2 is a flow chart showing a general flow from the creation of the outline of the advertisement of a product to distribution to a site according to the first embodiment. As shown in FIG. 2, first of all, a campaign project for a self product is transmitted from the company 12 to the advertising agency 14 (Step 201). The campaign project includes the presentation of a user class (purchasing class) to be a period, a budget and a target, for example. In the advertising agency 14, a manuscript is created according to the campaign project thus transmitted and is sent to the REP (Step 202). The manuscript displays the user class to be the period, the budget and the target.

The media plan creating server 18 generates an optimized media plan indicative of a site to which an advertisement is to be distributed, a period for the distribution and the prediction of an effect thereof based on the manuscript created by the advertising agency (Step 203), and returns the optimized media plan to the REP server 16 (Step 204). The method for creating the media plan will be specifically described later. The REP server 16 gives each site 22 an instruction for distributing an advertising banner according to the created manuscript for a predetermined site for a predetermined period based on data sent from the media plan creating server 18 (Step 205). In the predetermined site 22, therefore, the advertising banner is displayed for a predetermined period (Step 206).

The user class is classified to some extent according to the contents to be returned to the user for the sites 22-1, 22-2, . . . , 22-n on the internet. This classification includes “a site for office ladies”, “a site for men in twenties”, “a site for young housewives”, “a site for girl high school students”, “a business site” and the like. The classification is neither clarified nor defined and the site is simply characterized to some extent by the user class. In the present embodiment, the media plan creating server 18 generates distribution project data in consideration of the characterization of the site.

In order to generate the distribution project data, the media plan generating server 18 acquires necessary data from the audience behavior research server 20. The audience behavior research server 20 holds an access log for each sample user in the sample family in its own database 30. Accordingly, the media plan generating server 18 acquires data to be an aggregate of the access log in the database 30 from the audience behavior research server 20. FIG. 3 is a diagram showing an example of data to be given from the audience behavior research server to the media plan generating server according to the first embodiment. As shown in FIG. 3, the data include a user ID, the sex, birth date, residence and occupation of the user, and the access log of the user. Moreover, the media plan creating server 18 specifies a user's attribute (for example, a sex, an age, a taste and the like) and acquires data of a sample user included in the target user.

Description will be given to the structure of the media plan generating server 18 and the processing to be executed in the server 18. The media plan generating server 18 demands an index to manage the effect of an advertisement of an advertising banner based on the data to be the aggregate of the access log.

In the present embodiment, “impression”, “effective reach” and “click through ratio” are used for the index. The impression (PV) serves to add the number of contacts for each site. The great impression implies that viewing is carried out many times. In other words, if the value is maximized, the number of exposures can be maximized. The effective reach indicates how many viewers have watched the advertisement effective number of times or more. By maximizing the effective reach, it is possible to maximize the number of people to reach. The click through ratio implies a ratio at which a certain banner in a site is clicked.

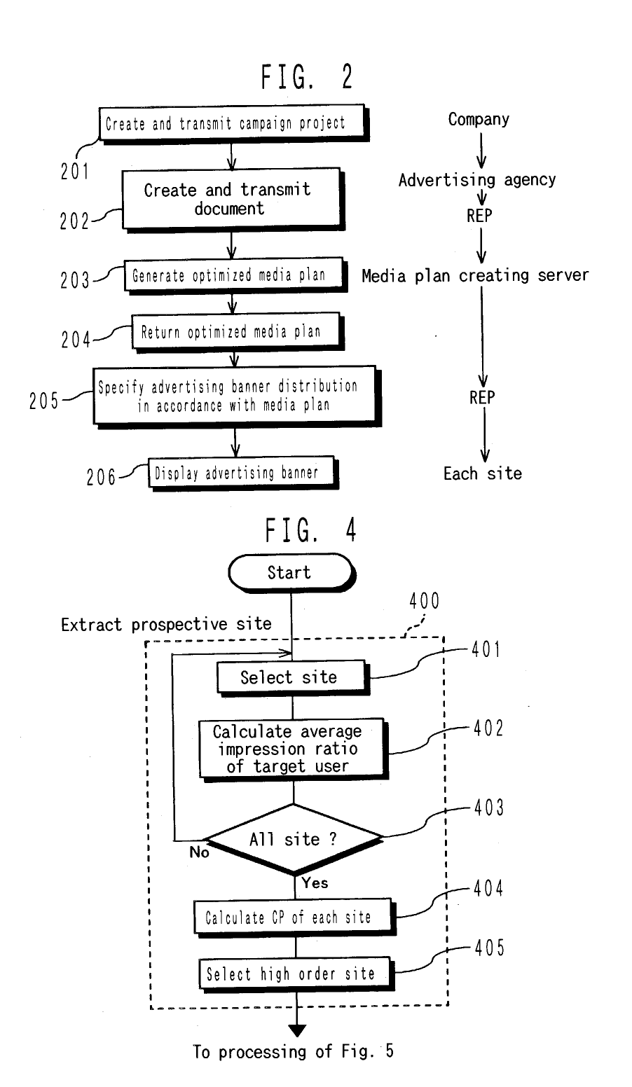

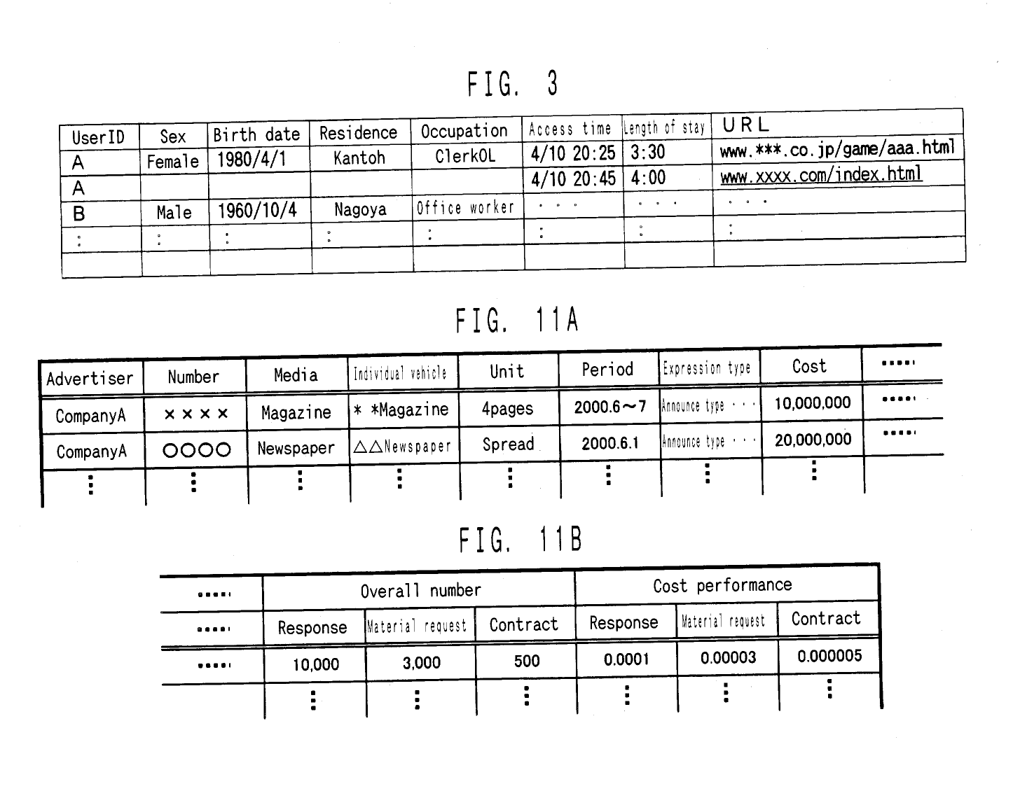

FIGS. 4 and 5 are flow charts showing a processing to be executed by the media plan generating server according to the first embodiment. As shown in FIGS. 4 and 5, in the media plan generating server 18, a processing of extracting a prospective site (Step 400) and a processing of calculating an efficiency (Step 500) are executed.

In the processing of extracting a prospective site, first of all, an average impression ratio of the target user is calculated (Steps 401 to 403). The impression ratio of a certain user is calculated by the following expression.

(a time in which the user stays in the same site)/(total time)

The total time implies a total time in a predetermined time zone. The total time can be set to one hour, for example, 6 o'clock to 7 o'clock in the afternoon. Accordingly, the average impression ratio is obtained by dividing the total impression ratio of the target user by the number of target users.

Referring to all the sites, when the average impression ratio is calculated, a cost performance (CP) for each of the sites is calculated (Step 404). The cost performance (CP) of a certain site is calculated by the following expression.

(average impression ratio of target user for certain site)/(cost of advertisement publication for the site)

The media plan generating server 18 compares the CPs and selects, as prospective sites, a predetermined number of sites from greater CP values (Step 405). Consequently, high order 100 sites are selected as the prospective sites, for example.

Next, the media plan generating server 18 finds a combination of sites in which an optimized media plan can be obtained. For example, also in the case in which 100 prospective sites are selected at the Step 404 and ten of them are combined, the number of combinations is countless. In the present embodiment, accordingly, the combination of the sites is determined according to the following procedure.

First of all, one prospective site is selected. For example, it is preferable that a prospective site having the highest CP should be selected. Next, the prospective site and another prospective site are combined to calculate an index value In more detail, the impression, the effective reach and the click through ratio are calculated based on the combination of the sites and the highest values are set to be an effective combination (see Step 503).

The impression, the effective reach and the click through ratio are calculated from different viewpoints, respectively. Therefore, a site having the highest values is rarely found. In the present embodiment, an index to which importance is given is selected. In other words, a desirable index can be selected depending on the characteristics of goods for the campaign. For example, an advertisement for novel goods needs to be seen by so many people irrespective of the reach. On the other hand, an advertisement for fully developed goods needs to be seen by people who have not seen the goods, and therefore, it is desirable that “once or more of effective reach” should be increased.

Alternatively, a composite index having a weight, as well as a single index, may be utilized. For example, it is also possible to set weights by selecting the “once of more of effective reach” as the most important index and the “impression” as the second most important index, respectively.

When a combination of two prospective sites is determined, a further site is added thereto (Step 506) and the same processing is repeated. By thus increasing the number of prospective sites gradually, it is possible to obtain the combination of prospective sites having a predetermined number of sites. In the present embodiment, the processings of adding a site and of determining a prospective site to be added are stopped at a certain time and an index value for another combination is also calculated. In the logic, consequently, it is possible to accidentally find a combination having a high index value even if it is excluded.

As described above, when the combination of the prospective site having a predetermined number of sites is determined, the media plan creating server 18 creates a media plan according to the combination (Step 507). The media plan includes information about a site on which an advertisement is to be published, a period for the publication, and a cost in a predetermined budget based on the publication of the advertisement for the period, and the prediction of the effect. The cost and the period are determined in consideration of an index value or a regular price because the regular price is determined for the publication of the advertisement on each site. Moreover, the reach, the impression and the click through in the combination of the sites based on the media plan also constitute a part of the prediction of the effect.

In the present embodiment, furthermore, the number of “unique audiences” and the “cost-impression” also constitute a part of the prediction of the effect. The unique audience implies a viewer excluding repetition. Even the same person tries a certain site many times, only one count is taken. Moreover, the cost-impression is also referred to as a CPI (Cost Per Impression) and implies an amount of money for the publication per impression, which can be obtained by the following expression.

(Amount of money for media plan)/(Total number of impressions)

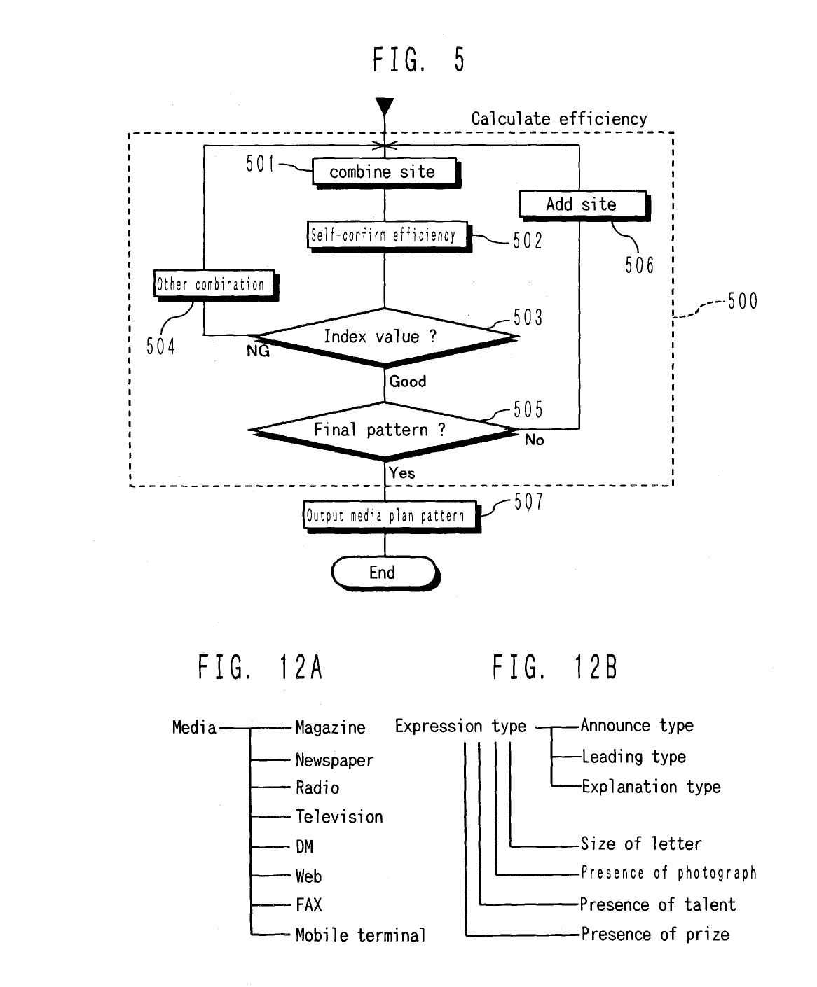

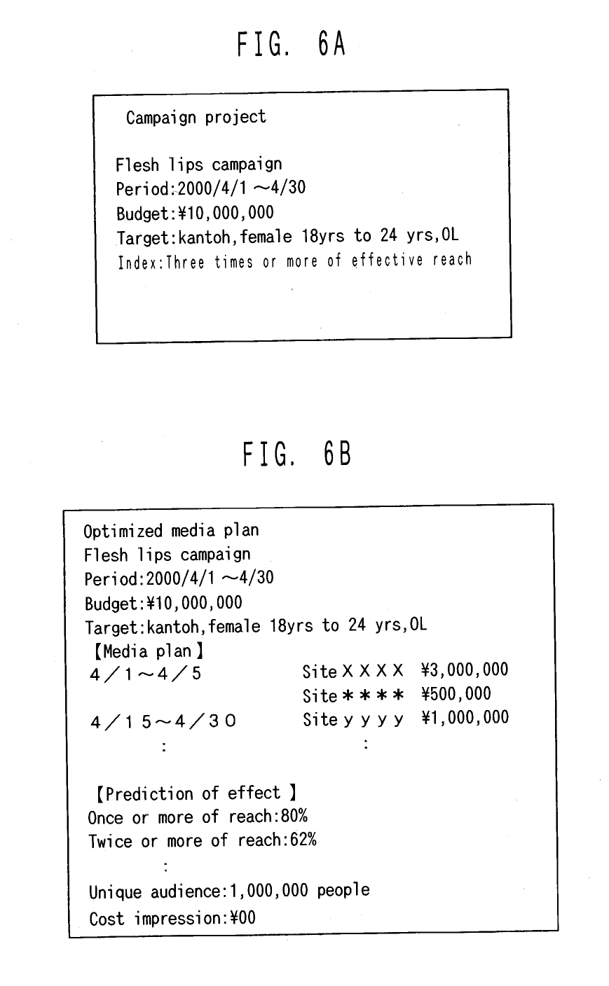

FIGS. 6A and 6B are diagrams illustrating an example of a campaign project and an optimized media plan calculated based thereon, respectively. For example, as shown in FIG. 6A, the campaign project includes a title, a campaign period, a budget, a target and an index. In the media plan creating server 18, the processings shown in FIGS. 4 and 5 are executed. Consequently, a media plan including the prediction of the effect and the like shown in FIG. 6B is created. Accordingly, it is preferable that the REP server 16 gives a predetermined site 22 an instruction for distributing an advertising banner based on the media plan given from the media plan creating server 18.

According to the media plan, as shown in FIG. 7, an advertising banner can be distributed to a site for office ladies (see the reference numeral 701), a site for young housewives (see the reference numeral 703) and a site for girl high school students (see the reference numeral 704) in the campaign for a lipstick, while it is possible to prevent the advertisement distributing banner from being distributed to a site for men in twenties (see the reference numeral 702) and a business site (a site for businessmen :see the reference numeral 705). While an object of the site can be grasped to some extent depending on the contents thereof, it cannot be changed into a numeric value properly. In the present invention, it is possible to objectively grasp a user class reading the site based on the access log of a sample user accumulated in an audience behavior database, thereby specifying more sites of a target user as a prospective site.

According to the present embodiment, when a destination to which a certain advertisement banner is to be distributed or the like is to be determined, data including the access log are acquired from the server of an internet audience behavior research institution accumulating an access log from a sample family, an impression ratio for each site through a user to be a target for the advertisement distribution is calculated based thereon, and a prospective site is extracted based thereon.

Furthermore, the combination of the prospective sites which is suitable for the advertisement distribution is found while calculating an index value. Accordingly, it is possible to distribute the advertising banner to a proper site. Consequently, the effect of the advertisement can be enhanced remarkably.

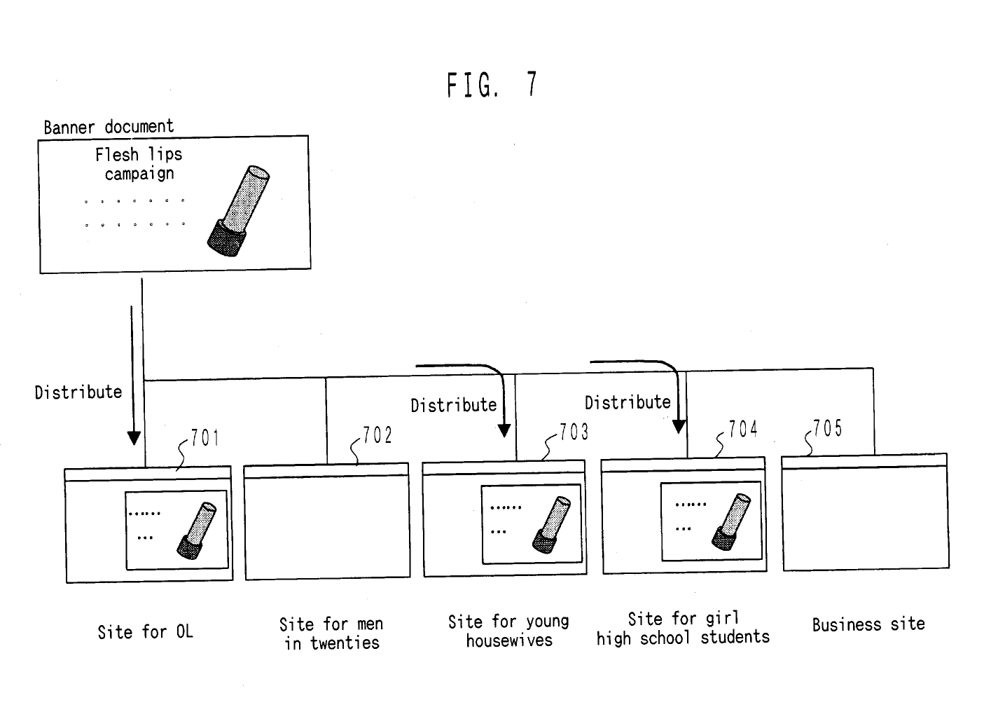

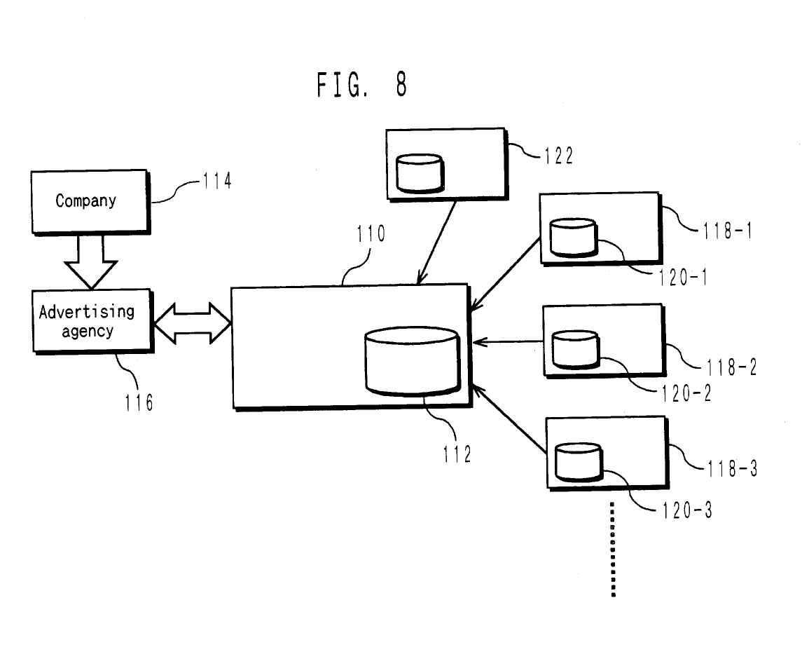

Next, a second embodiment of the present invention will be described. FIG. 8 is a block diagram schematically showing a media plan creating system and the vicinity thereof according to the second embodiment. As shown in FIG. 8, a media plan creating system 110 has a database 112.

An advertising agency 116 to which a campaign project of goods or the like is transmitted from a company 114 creates a manuscript of an advertisement based on the campaign project and transmits the manuscript to the media plan creating system 110. The media plan creating system 110 can accept information from systems (advertiser system) 118-1, 118-2, . . . of an advertiser (company). Furthermore, the media plan creating system 110 may accept data from a system 122 of another research institution (an institution for researching a response to an advertisement from a user). The advertiser system can store the response from latent customers utilizing internet or a CTI technique.

In this specification, advertisement media include mass media, that is, a newspaper, a magazine, a television and a radio and intercommunicating media (an interactive channel). The interactive channel has contents on a web such as a home page or a banner advertisement, a telephone to a call center, a return of a direct mail, a notification through a fax, a communication from a mobile terminal including a mobile telephone and a PDA and the like.

The advertiser systems 118-1, 118-2, . . . accommodate, the database (DB) 120, a response from a user (latent customer) to be an advertisement acceptor for an advertisement sent by themselves (an advertisement to the mass media and an advertisement from the interactive channel). As described above, the internet is utilized or a CTI unifying a telephone network and a computer is utilized.

The company 114 and the advertising agency 116 may be connected on-line through WAN or internet by a server or off-line. Moreover, the advertising agency 116 and the media plan creating system 110 may also be connected on-line or off-line. Furthermore, though the media plan creating system 110 and various advertiser systems 118 may be connected off-line, it is desirable that both should be connected off-line in order to minimize a time lag. Moreover, the advertiser systems 118-1, 118-2, . . . include an advertiser system owned by the company 114.

FIG. 9 is a flow chart showing a general flow from the creation of the outline of the advertisement of certain goods or the like to publication/distribution and the feedback of a result thereof according to the second embodiment. As shown in FIG. 9, first of all, a campaign project for a self product is transmitted from the company 114 to the advertising agency 116 (Step 901). The campaign project includes the presentation of the name of goods, a period and a budget, for example. In the advertising agency 116, a manuscript is created according to the campaign project thus transmitted and is sent to the media plan creating system 110 (Step 902). The manuscript displays a catchphrase, a period and a budget.

The media plan creating server 118 generates an optimized media plan indicative of media to which an advertisement is to be distributed, a period for the distribution and the prediction of an effect thereof based on the manuscript created by the advertising agency (Step 903), and returns the optimized media plan to the advertising agency 116. The method for creating the optimized media plan will be specifically described later. The advertising agency 116 publishes or distributes an advertisement to predetermined media for a predetermined period according to the optimized media plan thus transmitted.

A reflection (response) through the publication and distribution of the advertisement is transmitted to the company 114 and is therefore accumulated in the advertiser system 118 related to the company 114. Consequently, the media plan creating system 110 acquires these data (Step 904) and analyzes the data thus acquired (Step 905). The result of the analysis is accumulated in the media plan creating system 110 itself and is transmitted to the advertising agency 116 (Step 906).

According to the flow shown in FIG. 9, items to be executed on respective sides of the company 114, the advertising agency 116 and the media plan creating system 110 will be described with reference to FIG. 10.

In the company 114, a campaign object is set (see the reference numeral 1001). Moreover, a target is extracted in the advertising agency 116 (see the reference numeral 1002).

On the other hand, channel planning is carried out on the side of the media plan creating system 110 and a message type is determined (see the reference numeral 1003). The channel planning implies a media plan for each of media. A planning sheet is created by the channel planning. In other words, the planning sheet is a document or file including a campaign object, a target, a media plan for each of media and a message type.

Moreover, an advertisement is actually published and distributed according to a schedule sheet created based on schedule management or contents management (the reference numeral 1004) through the advertising agency 116.

A user's response for the publication or distribution of the advertisement is transmitted to the media plan creating system 110 through the advertiser system 118 of the company 114 and the media plan creating system 110 creates an effect measurement report (see the reference numeral 1005) based on the response. A document including the effect measurement report is an analyst report.

The operation of the media plan creating system 110 will be described below according to the flow of the creation of the advertisement, the creation of the media plan, and the publication/distribution of the advertisement and the feedback.

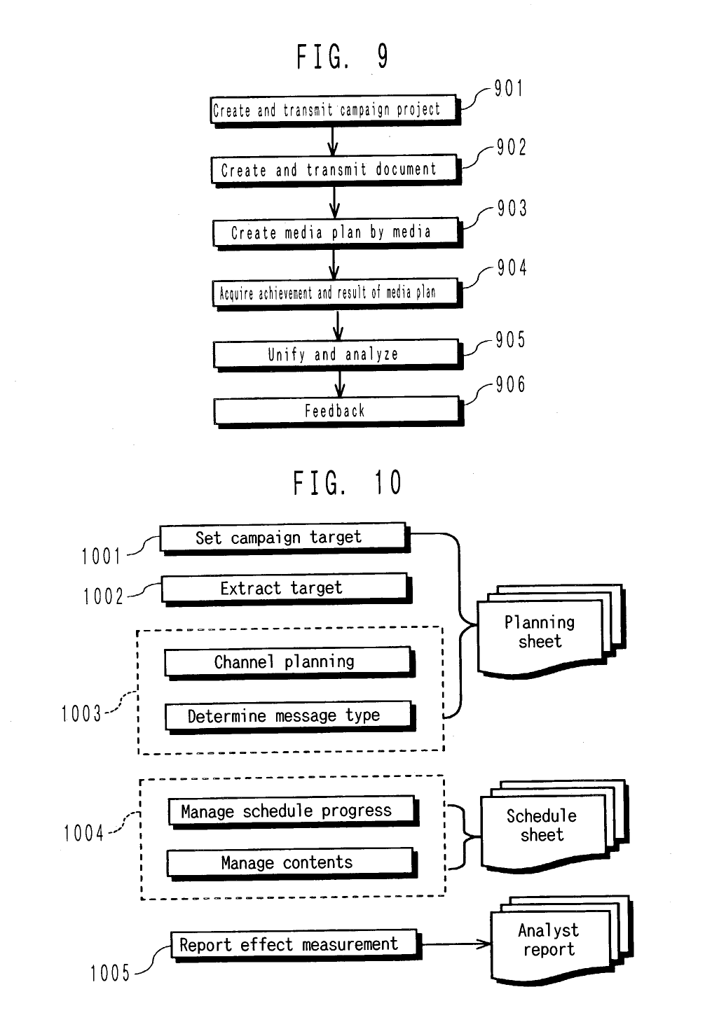

FIGS. 11A and 11B are diagrams showing the structure of a data group stored in a DB 112 of the media plan creating system 110 according to the second embodiment. As shown in FIGS. 11A and 11B, the DB 112 accommodates information about the publication or distribution of an advertisement related to a product of each advertiser or the like. In the present embodiment, the items of a set of data in the DB 112 include an advertiser, an advertisement number, a media type, an individual vehicle, a unit, a period, an expression type, a cost, an absolute number and a performance.

The advertiser indicates a company presenting an advertisement or the like. The advertisement number is given to uniquely specify the advertisement. The advertisement does not imply the whole advertisement presented to many media as a part of a campaign by an adviser but an advertisement presented for a specific period to a specific individual vehicle (a specific magazine or a specific TV program).

For example, a “material request number” to be utilized in the case in which a postcard for a response (an answer to a questionnaire or a request for a material) is added to a magazine advertisement or the material request number is printed on a part of the advertisement and is to be put on the postcard for the response is preferably made coincident with the advertisement number. Alternatively, in the case in which a response is to be demanded through a telephone, it is preferable that a telephone number such as a toll free number which is varied for each advertisement should be allocated to be an advertisement number.

In the present embodiment, as shown in FIG. 12A, the media include a magazine, a newspaper, a radio, a television, a direct mail (DM), a web (Web), a fax (FAX) and a mobile terminal. Each vehicle includes more specific individual vehicle. For example, a peculiar newspaper such as “** paper” or “** sports” is equivalent to the individual vehicle. In the television, a specific program name or the like is equivalent to the individual vehicle.

The unit indicates the size of the advertisement in the individual vehicle. For example, referring to paper media such as a newspaper or a magazine, the size of the advertisement and the number of pages are equivalent to the unit. In the media such as a radio or a television, a time required for one advertisement is equivalent to the unit.

The expression type represents the kind of an advertisement, that is, the contents of the advertisement in scale. For example, as shown in FIG. 12B, the expression type can indicate a format of an advertisement (an announce type for causing a product or the like to be known, a leading type for causing people to be interested in the product or the like, and an explanation type for explaining the contents of the product or the like), the size of a letter in the advertisement having letters, the presence of a photograph or an image, the presence of an artiste (talent), and the presence of a prize.

In the present embodiment, the reflection sent from the user viewing the advertisement is divided into three types, that is, a response, a material request and a contract. The response implies that the user viewing the advertisement has any response. The material request implies that a material for a product related to the advertisement or the like is requested for the advertisement. Moreover, the contract implies that the user finally purchases the product related to the advertisement. In the present embodiment, each cost performance for the cost of an advertisement is stored in the DB 112 together with the total number of responses, material requests and contracts for each advertisement. As shown in FIG. 11B, furthermore, the statistics of the attribute (a sex, an age, an occupation, a hobby and the like) of the user which carries out the response, the material request and the contract are included in the present embodiment.

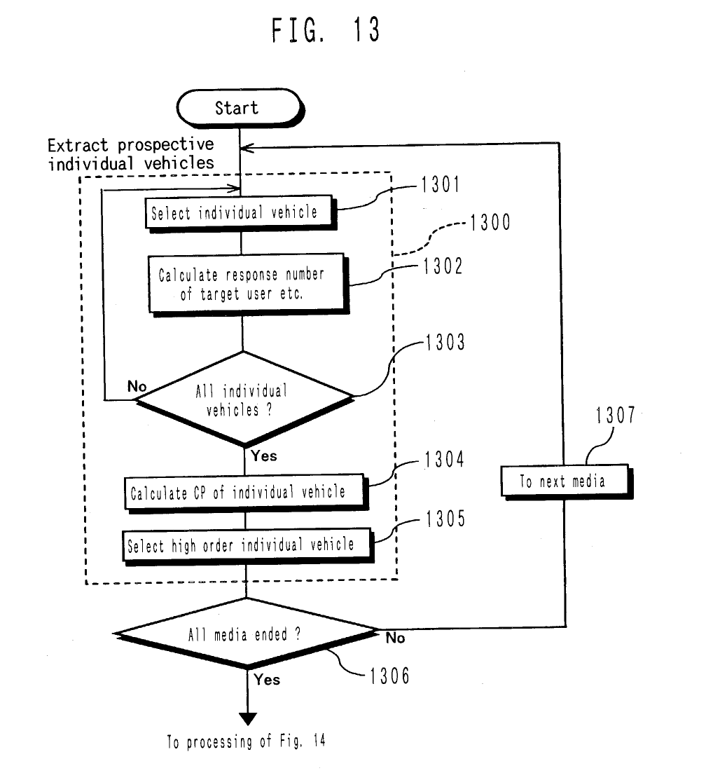

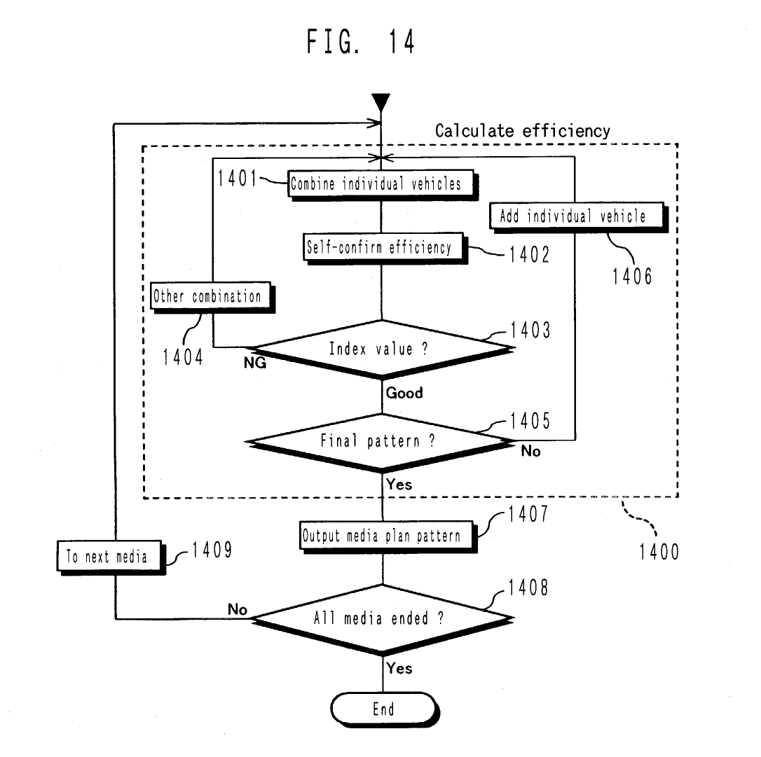

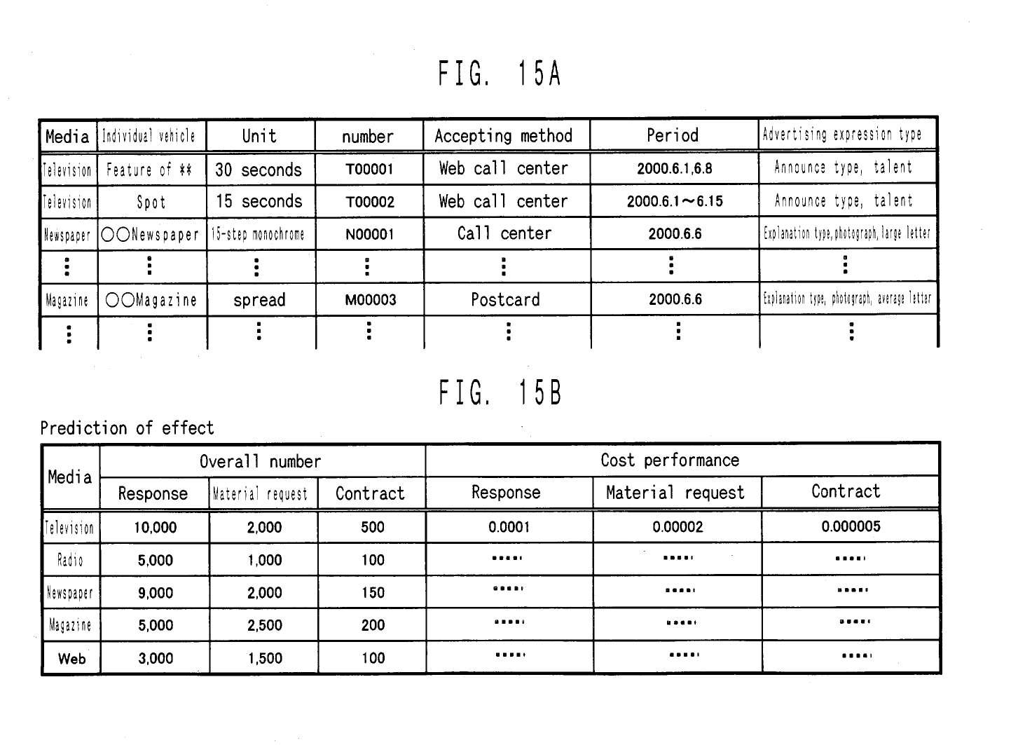

When a document created by the advertising agency 116 is received at the Step 902 in FIG. 9, the media plan creating server 110 executes a processing shown in FIGS. 13 and 14, where a prospective individual vehicle is extracted (Step 1300 in FIG. 13) and a combination of the individual vehicle is determined based on efficiency calculation (Step 1400 in FIG. 14).

In the extraction of the prospective individual vehicle, first of all, the respective absolute numbers of responses, material requests and contracts of a target user are calculated for each individual vehicle included for each of media (Steps 1301 and 1302). In more detail, the media plan creating system 110 can implement the calculation by investigating a user attribute related to the response, the material request and the contract in the data related to the noted (selected) vehicle with reference to the DB 112.

When the response, the material request and the absolute value of the target user are calculated for the individual vehicle, a cost performance for the individual vehicle is calculated (Step 1304). The cost performance CP is calculated by the following expression.

CP1=(number of responses of target user)/(cost of advertisement in the individual vehicle)

CP2=(number of material requests of target user)/(cost of advertisement in the individual vehicle)

CP3=(number of contracts of target user)/(cost of advertisement for the individual vehicle).

The CP1 to CP3 are added in a predetermined manner or are added with a predetermined weight so that the cost performance CP can be obtained.

The media plan creating system 110 compares the CP of the individual vehicle and selects a high order individual vehicle as a prospective vehicle in descending order of a CP value (Step 1305). Consequently, several ten high order individual vehicles (for example, “aa paper”, “bb sports”, “evening paper cc” and the like) are selected as prospective individual vehicles in a certain medium (for example, a newspaper).

The procdssings of the Steps 1301 to 1305 are executed for all the media (see Steps 1306 and 1307).

Next, the media plan creating system 110 finds a combination of the individual vehicle in which an optimized media plan can be obtained for each of media. For example, in the case in which thirty prospective the individual vehicles are selected in a certain medium (for example, a newspaper), there are many combinations obtained by every five individual vehicles. In the present embodiment, the combination of individual vehicle is determined according to the following procedure.

First of all, one prospective individual vehicle is selected. For example, it is preferable that a prospective individual vehicle having the highest CP value should be selected (see Step 1402). Next, the prospective individual vehicle and another prospective individual vehicle are combined to calculate an index value. In the present embodiment, the cost performance related to the response, the material request and the contract is utilized for the index value. Accordingly, the highest cost performance is determined as a combination of effective individual vehicles (see Step 1403).

In the present embodiment, it is possible to set the degree of importance of the cost performance related to the response, the material request and the contract. More specifically, it is possible to set the degree of importance depending on the case in which any reaction is preferably given from a user, the case in which it is important that the user should know a product, the case in which importance is attached to a contribution to actual sales and the like.

Alternatively, it is also possible to utilize a composite index having a weight as well as a single index. For example, it is also possible to select the “material request” as the most important index and the “contract” as the second most important index and to set respective weights.

When a combination of two prospective individual vehicles is determined, a further individual vehicle is added thereto (Step 1406) and the same processing is repeated. By thus increasing the number of individual vehicles in the combination of the prospective individual vehicles gradually, it is possible to obtain the combination of the prospective individual vehicles having a predetermined number of individual vehicles. In the second embodiment, the processings of adding the individual vehicle and of determining the individual vehicle to be added are stopped at a certain time and an index value for another combination is also calculated. In the logic, consequently, it is possible to accidentally find a combination having a high index value even if it is excluded.

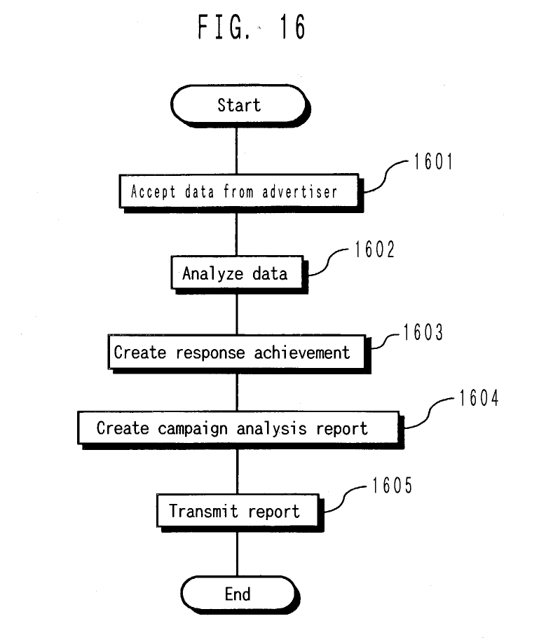

As described above, the combination of the prospective individual vehicles having a predetermined number of individual vehicles is determined for all the media (Steps 1408 and 1409). When the combination of the prospective individual vehicles related to all the media is determined, the media plan generating system 110 creates a media plan according to the combination. The media plan includes information about the individual vehicle on which an advertisement is to be published, a period for the publication, and a cost in a predetermined budget based on the publication of the advertisement for the period, and the prediction of the effect. FIGS. 15A and 15B are diagrams showing an example of the media plan. As shown in FIG. 15A, the media plan includes a unit for the individual vehicle, an advertisement number, a method of accepting a user's reaction, an advertisement period, an advertisement expression type and the like. Moreover, FIG. 15B lists the prediction of the absolute values of a response for each medium, a material request and a contract and the prediction of a cost performance in the prediction of an effect for the media plan.

The media plan is transmitted from the media plan creating system 110 to the advertising agency 116. In the advertising agency 116, a request for an advertisement is given to an application institution (a publishing company, a newspaper publisher, a broadcasting station or the like) of each medium along the media plan in the advertising agency 116.

When the advertisement is published or distributed to the individual vehicle, a user having an interest communicates with the advertiser side according to a postcard, a telephone number, a URL or the like in the advertisement. If an advertisement number can be specified uniquely based on a material request number or a telephone number, the advertiser (company) can grasp the number of responses, material requests and contracts given by the user in relation to the advertisement number. Moreover, it is also possible to accumulate user classes which give the response, the material request and the contract through the provision of information about a user attribute from the user.

It is desirable that a material request number and a telephone number related to the advertisement number should be bar-coded on a postcard or a material request ticket which is attached to a magazine or the like for the advertisement. Consequently, it is possible to input data in the advertiser system 18 more rapidly.

These accumulated information are analyzed through the media plan creating system 110 in the procedure shown in FIG. 16, and a result of the analysis is fed back to the advertising agency and the company.

The information about the response, the material request and the contract given from the user which are accumulated on the advertiser side are transmitted from the advertiser system 118 to the media plan creating system 110 (Step 1601). Next, the media plan creating system 110 analyzes the information transmitted from the advertiser (Step 1602) and the statistics related to the actual result of the response are created (Step 1603). Then, the media plan creating system 110 creates a campaign analysis report including a table for a response, a material request and a contract, a ranking table, a cost per response, material request and contract, a cross tabulation table and the like. The report thus created is fed back to the advertising agency 116 and the company 114 (Step 1605).

Moreover, the media plan creating system stores, in its own DB 112, data on a unit, a period, an expression type, a cost, and a response, a material request and a contract for the individual vehicle. These are utilized for creating a media plan based on the campaign of a company to be an advertiser or another company.

According to the second embodiment, a media plan for publishing or distributing an advertisement is created in consideration of the number of responses, material requests and contracts and the cost performance based on the contents (the unit, the period, the expression type and the cost) in the individual vehicle and the advertisement. Accordingly, also in the case in which there are a large number of individual vehicles, it is possible to create an optimized media plan for a response.

According to the second embodiment, moreover, it is possible to create a media plan in consideration of the response, the material request and the like in the same manner as in an advertisement for a company itself in addition to the creation of the media plan related to a campaign advertisement of a product or the like.

The present invention is not restricted to the above-mentioned embodiments but various changes can be made within the scope of the present invention in claims and are apparently construed to be included in the present invention.

For example, while the case in which an advertising banner of specific goods (for example, a lipstick) is to be distributed has been described in the first embodiment, the present invention is not restricted to the goods but can be utilized for optimizing a distribution destination for an optional advertising banner such as an advertising banner of a site itself, an advertising banner indicative of a service or the like.

Furthermore, the extraction of a prospective site and the optimization of the combination of the prospective site are not restricted to the algorithm but another method may be utilized.

Moreover, the extraction of a prospective individual vehicle and the optimization of the combination of the prospective individual vehicle are not restricted to the algorithm but another method may be utilized.

Furthermore, while the respective absolute numbers of responses, material requests and contracts and the cost performance have been taken into consideration in the second embodiment, the present invention is not restricted thereto. For example, any of them can be taken into consideration or other items may be taken into consideration if necessary.

In this specification, the function of one means may be implemented by two or more physical means or the functions of two or more means may be implemented by one physical means.

According to the present invention, it is possible to provide a method of determining an advertisement destination for optimizing a distribution destination of an advertisement and a system for optimizing the distribution.

According to the present invention, moreover, it is possible to provide a media plan creating system capable of creating a proper media plan to be published on an advertisement or distributed to various advertising media.

What is claimed is:

1. An advertisement distribution determining method of determining a site to which an advertising banner is to be distributed based on a media plan including a target user, comprising the steps of:
accepting a manuscript created through an advertising agency and/or a REP and including information indicative of a period, a budget and a target user;
acquiring data including an attribute of a sample user in a sample family and an access log of internet of the user;
selecting a predetermined number of prospective sites presumed to have an advertising effect based on an access log of the user which is coincident with conditions of the target user in the sample user;
calculating an index in relation to the prospective site to find a combination of the prospective sites; and
generating a media plan in which an advertisement period and a budget are allocated to each combination of the prospective sites, thereby transmitting the media plan.

2. The advertisement distribution determining method according to claim 1, wherein the attributes in the sample family and the related access log are acquired from an audience behavior database owned by an institution for researching an internet audience behavior.

3. The advertisement distribution determining method according to claim 1 or 2, wherein the sample user which is coincident with the condition of the target user is selected and a prospective site is selected based on an access log of the selected user.

4. The advertisement distribution determining method according to any of claims 1 to 3, further comprising the steps:
selecting the prospective site;
calculating an average impression ratio of each site by a selected user;
calculating a cost of advertisement publication of each site and a cost performance based on a ratio with the average impression ratio; and
setting, to a prospective site, a predetermined number of sites in high order of the cost performance.

5. The advertisement distribution determining method according to any of claims 1 to 4, wherein any of an impression, an effective reach and a click through ratio or an optional combination thereof is utilized as the index.

6. The advertisement distribution determining method according to claim 5, wherein any one of the impression, the effective reach and the click through ratio is selected.

7. The advertisement distribution determining method according to claim 5, wherein a plurality of weights of any of the impression, the effective reach and the click through are determined respectively and the index is calculated in consideration of the weight.

8. The advertisement distribution determining method according to any of claims 1 to 7, wherein the step of generating a media plan includes the step of generating information indicative of a period in which an advertising banner is to be distributed to each site and/or a cost required for the distribution for the same period.

9. A distribution optimizing system for determining an optimum site to which an advertising banner is to be distributed based on a manuscript created through an advertising agency and/or a REP and including information indicative of a period, a budget and a target user on the basis of a media plan including the target user, comprising:
prospect site selecting means for acquiring data including an attribute of a sample user in a sample family and an access log of internet of the user and selecting a predetermined number of prospective sites presumed to have an advertising effect based on an access log of the user which is coincident with conditions of the target user in the sample user;
index calculating means for calculating an index in relation to the prospective site to find a combination of the prospective sites; and
media plan generating means for, generating a media plan in which an advertisement period and a budget are allocated to each combination of the prospective sites,
wherein the media plan having the distribution destination optimized is transmitted to the REP and/or the advertising agency.

10. The distribution optimizing system according to claim 9, wherein the prospective site selecting means has average impression ratio calculating means for calculating an average impression ratio of each site by a selected user, and
cost performance calculating means for calculating a cost of advertisement publication of each site and a cost performance based on a ratio with an average impression ratio,
a predetermined number of sites in high order of the cost performance being determined to be a prospective site.

11. The distribution optimizing system according to claim 9 or 10, wherein the index calculating means has accepting means for accepting selection of any of an impression, an effective reach and a click through ratio or a combination thereof and accepting a weight of each element in the combination.

12. A media plan creating method of creating a media plan specifying at least one individual vehicle to which an advertisement is to be published or distributed based on an advertisement manuscript, comprising the steps of:
accepting a manuscript sent from an advertiser and/or an advertising agency to which information including an advertisement period and a budget is given;
referring to information indicative of the individual vehicle indicative of a medium to which an advertisement stored in a database and published or distributed has specifically been published or distributed, contents of the advertisement, a cost of the advertisement and a user's reaction to the advertisement; and
creating a media plan including an advertisement period and a budget for a selected one of the individual vehicles to maximize the user's reaction.

13. The media plan creating method according to claim 12, wherein the information indicative of the user's reaction to the advertisement includes at least the number of responses given from the user, the number of material requests given from the user, and the number of contracts made by the user.

14. The media plan creating method according to claim 12 or 13, further comprising the steps of:
acquiring a user's reaction based on publication and distribution of an advertisement on the basis of the media plan; and
storing the user's reaction in a database in relation to the individual vehicle, contents of the advertisement and a cost of the advertisement.

15. The media plan creating method according to any of claims 12 to 14, wherein the manuscript includes information indicative of a user's attribute to be a target,
information indicative of the user's reaction is stored in the database for each user's attribute,
the step of creating a media plan has the step of selecting a plurality of the individual vehicles in consideration of a ratio of the user's reaction having the user's attribute to a cost of an advertisement related to the individual vehicle, and
the step of obtaining a combination of the individual vehicles to optimize the user's reaction.

16. A media plan creating system for specifying a plurality of individual vehicles to which an advertisement is to be published or distributed based on an advertising manuscript and for creating a combined media plan, comprising:
a database for storing information indicative of the individual vehicle indicative of a medium to which an advertisement published or distributed has specifically been published or distributed, contents of the advertisement, a cost of the advertisement and a user's reaction to the advertisement; and
media plan creating means for creating a media plan including an advertisement period and a budget for a selected one of the individual vehicles to maximize the user's reaction based on a manuscript sent from an advertiser and/or an advertising agency to which information including an advertisement period and a budget is given.

17. The media plan creating system according to claim 16, wherein the information indicative of the user's reaction to the advertisement includes at least the number of responses given from the user, the number of material requests given from the user, and the number of contracts made by the user.

18. The media plan creating system according to claim 17, wherein the media plan creating means selects a combination of a plurality of individual vehicles in consideration of any of a cost of an advertisement related to the individual vehicle, the number of responses, the number of material requests and the number of contracts.

19. The media plan creating system according to any of claims 16 to 18, wherein the manuscript includes information indicative of a user's attribute to be a target,
the database stores information indicative of the user's reaction for each user's attribute, and
the media plan creating system refers to the user's attribute of the target user in the manuscript to create a media plan in order to maximize the user's reaction having the user's attribute for the individual vehicle.

20. The media plan creating system according to claim 19, wherein the media plan creating means selects a plurality of individual vehicles in consideration of a ratio of the user's reaction having the user's attribute to a cost of an advertisement related to the individual vehicle, and
obtains a combination of the individual vehicles to optimize the user's reaction.
